(19) United States
(12) Patent Application Publication
(10) Pub. No.: US 2006/0206261 A1
(43) Pub. Date: Sep. 14, 2006

(54) Systems, methods, and media for route control of a vehicle

(76) Inventors: Faheem Altaf, Pflugerville, TX (US); Jerry Walter Malcolm, Austin, TX (US); Kumar Ravi, Cedar Park, TX (US); Eric Siegfried Rybczynski, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/077,325

(22) Filed: Mar. 10, 2005

(51) Int. Cl. G01C 21/34

(52) U.S. Cl. 701/209; 340/995.19

(57) ABSTRACT

Systems, methods and media for programming a vehicle ignition key with route information are disclosed. More particularly, hardware and software are disclosed for obtaining map data from a map data source; deriving route information from the map data; and transferring the route information to a vehicle ignition key. When the driver starts the vehicle with the ignition key, the ignition key transfers the route information stored on it to a receiver in the vehicle. The route information is used to prevent the vehicle from traveling away from an authorized route or outside a specified area.

### FIELD

The present invention is in the field of vehicle route monitoring and protection of the vehicle from unauthorized use. More particularly, the invention is in the field of programming a vehicle key to provide route information to the vehicle.

### BACKGROUND

Many automobiles, trucks, tractors, aircraft and other vehicles include a positioning tracking system, such as a Global Positioning System receiver. The Global Positioning System (GPS), as exemplified by NAVSTAR/GPS, is an accurate, three-dimensional navigation system. The GPS has a constellation of twenty four satellites that orbit the earth twice a day at an altitude of about 10,898 miles. The satellites orbit the earth in six overlapping orbital planes that are based on the equatorial plane of the earth. The orbits of the satellites enable any GPS receiver near the surface of the earth to receive signals from at least four satellites at any one time, although position information can be obtained with only three satellites. Each satellite continuously broadcasts pseudo-random codes at L-band frequencies, L1 at 1575.42 Mhz and L2 at 1227.6 Mhz. Each satellite broadcasts a signal that includes the time the signal left the satellite and satellite position information. A GPS receiver decodes the satellite signals to determine its position.

Auto manufacturers equip many vehicles today with a GPS receiver to inform a vehicle operator of his or her location. They also provide a map and address database containing map and address data that may be displayed on a video monitor mounted in the vehicle in view of the driver of the vehicle. An icon in the display shows the vehicle's position. The road traveled by the vehicle is shown, as well as crossroads, nearby roads and possibly other landmarks. As the vehicle moves, the display shows the route traveled by the vehicle. A keypad enables the user to key in an address of origin and a destination address. Given this information, the navigation system determines a route to the destination from the origin. Additionally, given the vehicle's present position, the destination address, and the map data, the navigation system can compute a route from the vehicle's present position to the destination. The navigation system may display directions along with a map showing the current location and the route to travel. For example, the route to be taken may be highlighted on the display. The directions may also be given aurally. Thus, when the user approaches an intersection, an electronically generated voice might say, “Turn right in one-fourth mile.” As the user turns right, the navigation system may rotate the displayed map counterclockwise to display the vehicle heading toward the top of the display along the prescribed route.

With the advent of GPS vehicle navigation as described above, vehicle owners may find it feasible to prescribe a route for a user of the vehicle. For example, a delivery service may prescribe a route to be taken by an employee-driver from a starting location to a destination. A car rental company may monitor the route of a rented vehicle to determine if the vehicle has been taken out of state or country in violation of the rental contract. Thus, the navigation system may store in memory the actual route taken by a vehicle. This route can be displayed and viewed upon return of the vehicle to determine whether the route taken was authorized. In some situations, rather than specifying a route, the navigation system may specify the radius of travel from a center point. For example, a courier service may specify that its vehicles remain within a certain radius roughly corresponding to the service area of the courier service.

Some have proposed mechanisms for turning off the vehicle's engine if the driver deviates from the specified route or authorized area of travel. See, for example, U.S. Pat. No. 5,532,690. Thus, the navigation system installed in the vehicle will monitor the actual route taken and warn the driver if he or she deviates from the prescribed route or area. If the driver does not heed the warning and remains outside the prescribed route, the system shuts the engine off. This helps prevent theft or other unauthorized use of the vehicle.

A keyboard or smart card reader provides the prescribed route or authorized area of travel to the navigation system. In this system, an authorized user, such as the vehicle owner, identifies himself to the system using his password. The authorized person, upon authentication, uses a keypad to input route information such as the point of origin and a destination. The navigation system then determines an authorized route using the map database for traveling from the point of origin to the destination. The driver must follow the prescribed route or the engine will be turned off.

A limitation of prior art navigation systems is the requirement for on-board equipment to receive the route information from an authorized user. For example, the navigation system must include a keypad or wireless interface to enable the user to prescribe the authorized route. When a keypad is used, the authorized user must physically enter the vehicle to input the route information. Alternatively, the navigation system must include a special receiver to receive the route information from a remote source. There is, therefore, a need to transfer route information to a vehicle to prevent unauthorized use thereof without the use of additional on board equipment.

### SUMMARY

The problems identified above are in large part addressed by systems, methods and media for programming a vehicle navigation system using a vehicle ignition key to prevent unauthorized use of the vehicle. Embodiments include transferring route information to a vehicle ignition key. The vehicle ignition key is capable of sending a signal to enable a driver to start the vehicle. A mechanism such as a transmitter or an encoded magnetic strip in the vehicle ignition key also transfers the route information from the vehicle ignition key to a navigation system of the vehicle. The route information transferred to the vehicle key may be derived from a map data source such as a map database. Route information may include, for example: coordinates of one or more routes between two locations; a radial distance from a central location; a boundary beyond which travel is not permitted; an upper limit of permissible travel time; and/or permissible dates of travel. Accordingly, route information includes one or more authorized conditions of travel.

According to an aspect of the invention, a vehicle owner or other authorized person uses a computer system to access map data. The map data may be downloaded to the computer system from an internet website. Or the map data may be on the computer system's hard drive. Or the map data may be obtained from a compact disk. Typically, a map database will prompt a user for information concerning a route, such as point of origin and destination. The map database will generate route information in response to the information input by the user. Using the map data, which may include a plurality of routes between an origin and a destination point, an authorized user specifies the route information to apply as conditions of use of the vehicle. The computer system transfers route information to the ignition key used to start the vehicle. When the driver uses the vehicle ignition key to start the engine of the vehicle, the vehicle ignition key transfers the route information to a navigation system of the vehicle. Thus, in one embodiment of the invention, the vehicle ignition key has electronic memory to store route information and processing circuitry to receive route information and to transmit route information. Another embodiment uses a flat card with an encodeable magnetic strip as a key that enables transfer of route information to the key and to the vehicle. In yet another embodiment, the routing information can be specified by an authorized user and then transmitted to an authorized driver by e-mail over the internet, intranet or other network. The driver could then use his or her computer to receive the e-mail containing the route information and transfer that information to the vehicle's ignition key. This is especially useful for a commercial enterprise with a fleet of vehicles spread out over a large geographical area.

According to another aspect of the invention, the vehicle navigation system determines whether use of the vehicle by the driver is authorized. Thus, if the driver deviates from a prescribed route, as specified by the route information, by more than a predetermined amount, the navigation system warns the driver. For example, the navigation system may warn the driver if he drives beyond a certain radius, or drives outside a specified boundary. If the driver does not heed the warning, then the navigation system causes the vehicle's engine to safely shut off. The vehicle engine may also be safely shut off when the time of use of the vehicle exceeds a predetermined length of time.

According to another aspect of the invention, a computer system can generate and assign multiple routes to different vehicle keys from a central location. The computer system then encrypts the routes and sends them by email to the various locations of the keys, each key operating to start a different vehicle. For security, the computer system emails a unique key identifier with the route intended for that key. Then, the computer system can ensure that a key will only receive the route information intended for it.

Another embodiment of the invention provides a machine-accessible medium containing instructions effective, when executing in a data processing system, to cause the system to perform a series of operations for generating and transferring route information to a vehicle ignition key. The series of operations generally include obtaining map data, deriving route information from the map data, and transferring the route information to the vehicle's ignition key. The map data from which the route information is derived may be downloaded from the internet or obtained from a hard drive or compact disk or other non-volatile memory.

Another embodiment of the invention provides a machine-accessible medium containing instructions effective, when executing in a data processing system, to cause the system to perform a series of operations for receiving route information from an ignition key, comparing this route information with the vehicle's position to determine if the vehicle has deviated from an authorized use. The series of operations generally include issuing a warning to the driver that the vehicle has deviated from its authorized use and shutting down the vehicle's engine if the warning is not heeded by the driver.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a system embodiment, including a vehicle navigation and control system and a vehicle key.

FIG. 2 depicts another system embodiment, including a computer system for obtaining, processing, and transmitting route information.

FIG. 3 depicts a flow chart for implementing an embodiment for providing route control.

FIG. 4 depicts an embodiment for providing different routes to different vehicles.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

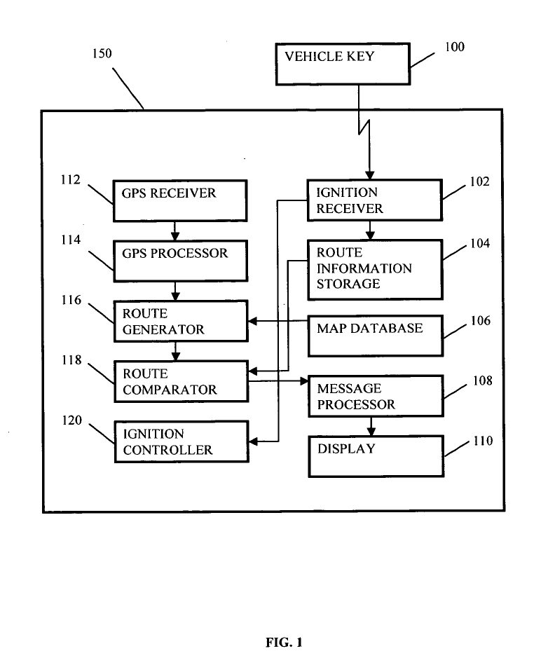

Generally speaking, embodiments include a system for programming route information onto a vehicle ignition key and for transferring route information from the vehicle key to an ignition receiver in the vehicle. An embodiment for transferring route information from the vehicle key to the vehicle and for processing route information to control the route of the vehicle is shown in FIG. 1. FIG. 1 shows a vehicle ignition key 100, and a vehicle navigation and control system 150 mounted in a vehicle. Vehicle ignition key 100 receives, stores and transmits route information. Thus, vehicle ignition key 100 may comprise a receiver for receiving digital information, memory for storing that information, and a transmitter for transmitting that information to the vehicle. In other embodiments, vehicle ignition key 100 is a card with an encode-able strip. Route information may include a point of origin, a destination and a route there between; an array of coordinates of a set of roads to be traveled, a radius from a point, coordinates of a geographical boundary, etc.

As will be described below, vehicle ignition key 100 receives route information from a computer system. Ignition key 100 transmits an encoded ignition signal to an ignition receiver 102 within vehicle navigation and control system 150 to enable a user of the vehicle to start the vehicle. In one embodiment, the user depresses a button on the key to cause the ignition key 100 to transfer route information to ignition receiver 102. In other embodiments, ignition receiver 102 receives the ignition code for starting the vehicle and route information automatically when the key is brought into proximity of the ignition receiver. Vehicle ignition key 100 may also contain a code that, when transmitted, enables the user to unlock or lock the doors of the vehicle.

Ignition receiver 102 receives the encoded ignition signal from ignition key 100 and processes it to produce an ignition code. Thus, ignition receiver 102 contains electronic circuitry to receive and decode the ignition signal transmitted by ignition key 100. Ignition receiver 102 sends the ignition code to ignition controller 120, which determines if the ignition code is correct. If correct, ignition controller 120 enables the key holder to start the engine of the vehicle.

Additionally, ignition receiver 102 receives and decodes route information from ignition key 100. The route information provided by ignition key 100 may include an origin point and destination point, a set of roads to which travel is restricted, a date authorized for travel, and an authorized time of use of the vehicle. Further, route information may include a maximum distance of deviation from the prescribed route. For instance, route information may include the coordinates of a boundary beyond which travel is unauthorized. In some embodiments, route information storage 104 stores route information that includes a radius of travel about a point of origin. Route information storage 104 may comprise random access memory (RAM) for storing the information. The navigation system accesses data stored in route information storage 104 for determining and controlling use of the vehicle.

Vehicle navigation and control system 150 further includes a GPS receiver 112 that receives and decodes signals from a plurality of GPS satellites that orbit the earth to recover data from each satellite concerning GPS system time and satellite positions. GPS processor 114 receives the data recovered by GPS receiver 112. and processes the data to produce the position of the receiver 112, and hence, the position of the vehicle. Navigation and control system 150 uses this position information to determine deviation of the vehicle from a prescribed position, route or area. Thus, GPS processor 114 continually updates the vehicle's current position and determines if that position deviates from an authorized route.

Vehicle navigation and control system 150 also includes a route generator 116, which receives route information from route information storage 104 and also receives data from a map database 106. Utilizing the information received from route information storage 104 and map database 106, route generator 116 generates information for displaying and highlighting a route on a map to be displayed by a display 110. The route information from route information storage 104 may comprise coordinates of an origin and a destination point, as well as coordinates along a route there between. Route generator 116 performs the graphical computations necessary to cause the route to be displayed by display 110.

Vehicle navigation and control system 150 includes a route comparator 118, which compares the position of the vehicle received from GPS processor 114 to the permissible locations along the authorized route or in the authorized area. Thus, route comparator 118 may compare the current position coordinates of the vehicle, as determined by GPS processor 114, to the coordinates of a route obtained from route information storage 104. When the position of the vehicle deviates from the authorized route by more than a predetermined distance or when the vehicle does not otherwise follow the authorized route, route comparator 118 sends a signal to message processor 108. Message processor 108 generates messages to be displayed by display 110. In one embodiment, route comparator 118 computes a distance between the position of the vehicle and the closest point along the prescribed route. If this distance exceeds a predetermined distance, message processor 108 generates a message to be displayed on display 110 showing the distance of deviation and warning the driver of the deviation. In another embodiment, route comparator 118 determines whether the distance from a point of origin to the position of the vehicle exceeds a predetermined distance. In that event, message processor 118 produces a warning message to be displayed on display 110. In yet another embodiment, route comparator 118 determines if the vehicle has crossed a boundary. In addition, or in the alternative, to displaying a warning, the system may announce the warning by way of an audio speaker. Thus, the driver will be aware of the warning by hearing it even if he can't take his eyes off the road to view the display.

Vehicle navigation and control system 150 also includes a map data base 106. Map database 106 comprises a compilation of map data, including names and locations of streets, highways, and roads. Map database 106 also includes street addresses. Map database 106 further contains position coordinates, such as latitude and longitude, for the locations in the map. Map database 106 may be stored in read-only-memory (ROM) or may be provided on a disk that can be inserted into a disk drive such as a CD or DVD disk drive. Map database 106 may comprise map data for an area, a state, a region, or an entire country or continent.

Message processor 108 generates messages that may be displayed on display 110 or communicated aurally to the driver by way of a sound speaker. Messages generated by message processor 108 include driving directions and warnings. Normally, as the driver drives the prescribed route, message processor 108 will generate messages such as distance to the next turn, directions to turn at the next intersection and the like. In the event the driver has deviated from a prescribed route, as determined by route comparator 118, route generator 116 may generate a route to return to the prescribed route. Message processor 108 generates driving directions to return along the route determined by route generator 116. Message processor 108 may also generate a warning to notify the driver when he or she has deviated from the prescribed route, and may also warn the driver that the vehicle will be stopped if the driver does not promptly take steps to return to the designated route.

Vehicle navigation and control system 150 also includes an ignition controller 120. When ignition key 100 transmits the proper ignition code, ignition controller 120 enables the vehicle's ignition system so that the driver can start the vehicle engine. Ignition controller 120 also operates to turn the engine off when the driver has deviated from the authorized route or when he has exceeded a specified boundary of operation. This will only occur if the driver has failed to heed warnings to return to the authorized route or to within the specified boundary. In one embodiment, ignition controller also operates to turn the engine off when the driver has exceeded the authorized time for travel. Thus, if the driver is authorized to drive the vehicle for one hour, the vehicle engine may automatically be turned off when that time is exceeded. It will be understood that means exist in the art and means will be developed for safely bringing a car to rest and such safe means may be implemented.

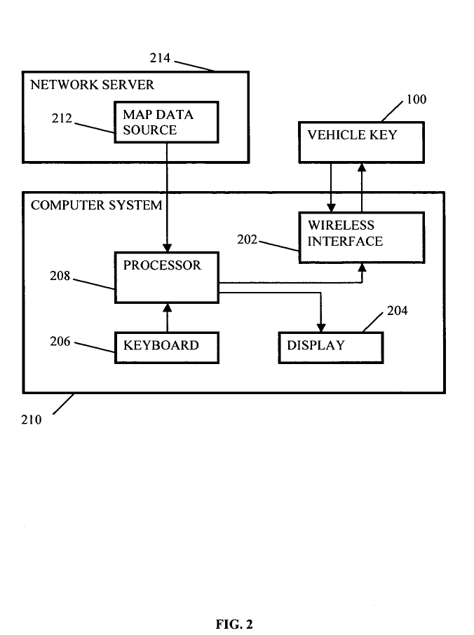

FIG. 2 shows a system for programming the vehicle ignition key 100 with route information. A computer system 210 is provided that enables the user to download map data from map data source 212 provided by way of a network server 214. Alternatively, map data may be provided on a hard drive of computer system 210 or on a disk such as a CD or DVD inserted into a disk drive of computer system 210. Map data may comprise coordinates of roads and features of a geographical area from which route information can be derived. Computer system 210 may comprise a personal computer, workstation, laptop computer, notebook computer, handheld computing device or the like. Such computer systems typically comprise a central processing unit (CPU) 208 and associated volatile and non-volatile memory, including random access memory (RAM) and basic input/output system read only memory (BIOS ROM), a system monitor 204, a keyboard 206, one or more flexible diskette drives, a CD-ROM drive, a fixed disk storage drive (also known as a “hard drive”), a pointing device such as a mouse, and an optional network interface adapter. Examples of such personal computer systems are International Business Machine Corp.'s (IBM's) PC 300, ThinkCentre, ThinkPad, Aptiva, and IntelliStation series.

To program the vehicle ignition key 100 with route information, the user initiates a software program executed by processor 208. The program may require a password to verify that the user has the authority to program vehicle ignition key 100. Processor 208 is in electrical communication with a network server 214 by way of a network channel such as phone line or cable or by wireless transmission and reception. The user causes processor 208 to initiate communication with network server 214 by way of keyboard 206. For example, the user may launch a network browser such as Internet Explorer or Netscape Navigator. The user causes processor 208 to access a website that has a map data source 212. Map data may comprise coordinates of roads and features of a geographical area from which route information can be derived. The user may designate a starting address and a destination address. From this information, computer system 210 provides at least one route between the two points. In one embodiment, the user may specify the quickest route or the route of shortest distance between the two points. In another embodiment, the user may select among a plurality of routes determined by computer system 210.

Processor 208 receives map data from map data source 212. This map data may be displayed on display 204, which comprises a color video monitor such as a flat panel display. The user may select a route from among a plurality of alternative routes displayed by display 204. Computer system 210 also allows the user to input parameters such as point of origin, destination, radius, geographical boundaries, etc. From information about the authorized route that is input by the user, and from map data received from map data source 212, computer system 210 may compute additional information that is important in choosing a route. For example, computer system 210 may compute the estimated time and fuel it takes to travel various routes between a specified starting location and a specified end location. Knowing the estimated time of travel, the user may specify additional time to accommodate factors such as rush hour traffic that influence the actual time of travel from the starting point to the destination.

Once the user specifies the route information, including time and date of travel, computer system 210 transmits this information to vehicle ignition key 100 by way of wireless interface 202. Wireless interface 202 comprises a standard wireless interface installed to provide communications between computer system 210 and peripheral devices or another computer. In the alternative, an embodiment could include a peripheral card reader/writer to read from and write to a key card. In addition to programming vehicle ignition key 100 with route information, processor 208 may also read data from vehicle ignition key 100 to verify the route information it contains. As will be explained in more detail below, each key has its own unique identifier that is stored on the key. This is to ensure that the key to a particular vehicle receives the routing information intended for it.

Once the vehicle owner or other authorized person programs ignition key 100 with the desired route information, the vehicle owner can give the ignition key to a driver. When the driver uses the ignition key to start the vehicle, the ignition key transfers the route information to the ignition receiver as explained above. In one embodiment, the user may initiate the transfer of the ignition code and route information by depressing a button on the vehicle ignition key. In another embodiment, the vehicle key is a card that is swiped or brought in proximity to a card reader to transfer route information from the card to the ignition receiver.

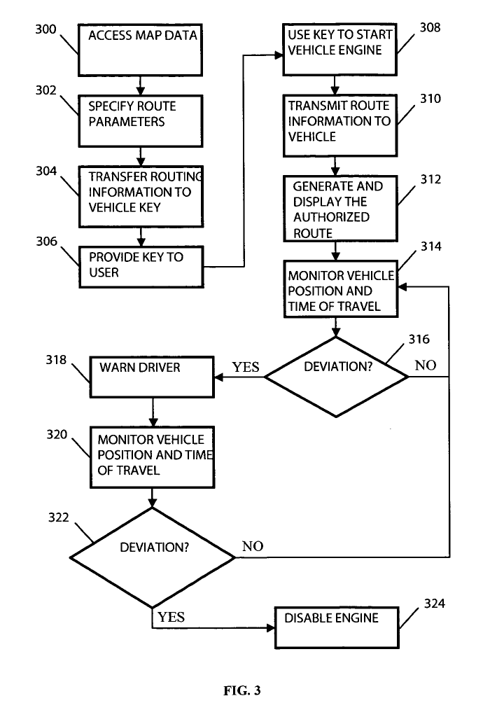

FIG. 3 shows a flow chart for generating and transferring route information to a vehicle key, transferring the route information from the vehicle key to the vehicle and monitoring and controlling the route of the vehicle. The owner of the vehicle, or other authorized person, accesses map data from a map data source, (element 300). As noted above, the owner may download map data from the internet or from a hard drive or compact disk. The map data may include a set of routes from a point of origin to a destination point. Also, the map data may include sets of coordinates with each set of coordinates being for a different route. The map data may further include an estimate of the time it takes to travel each one of the alternative routes.

Next the user specifies route information (element 302). The user may select any one of the routes identified by the map data. The user may also specify a maximum permissible distance of deviation from the selected route. Using the estimated time of travel provided by the map data, the user may also prescribe an authorized time of travel. The user may also specify authorized dates of travel. In some embodiments, the user may specify a radius from a selected geographical location, beyond which the driver cannot travel. In other embodiments, the user may specify boundaries within which travel is authorized.

After the user determines the route information, (element 302), the user then initiates transfer of the route information to the vehicle ignition key (element 304). As noted, this may be done using a wireless interface that transmits the information to the ignition key. In the case of a card, a card writer transfers the information to the card. Once the owner programs the key, the owner provides the key to the person the owner gives permission to drive the vehicle (element 306).

The driver uses the programmed vehicle ignition key to start the vehicle's engine (element 308). More specifically, the vehicle ignition key transmits a code to the vehicle's ignition receiver to enable the engine to be started. The vehicle ignition key also transmits to the ignition receiver the route information prescribed by the owner (element 310). Using the route information provided by the vehicle ignition key and map data from a data base in the vehicle's navigation and control system, the system generates and displays the authorized route (element 312). Also, the system may display the remaining authorized time for traveling the designated route.

As the driver drives the vehicle, the navigation and control system monitors the vehicle's current position and time of travel (element 314). The GPS processor determines the vehicle's current position quite accurately, within a few meters. While monitoring the vehicle's position, the system also determines whether the driver is deviating from the prescribed route (element 316) by some predetermined amount. For example, the navigation and control system determines whether the vehicle has exceeded a prescribed radius from a central location, or determines if the vehicle has traveled beyond a specified boundary. If not, the system continues to monitor the vehicle's position (element 314).

If the driver has deviated from the authorized route or area of travel by more than the predetermined amount, the system generates a warning message (element 318), warning the driver to return to the authorized route or area. The system communicates this warning to the driver by way of a display or an oral warning or both. Also, if the driver has exceeded, or will soon exceed, the authorized time of travel, the system will warn the driver to immediately drive to the prescribed destination point. In one embodiment, in addition to warning the driver that the authorized bounds have been exceeded, the system also gives the driver directions to promptly return to the prescribed route or area.

Once the driver is given a warning, the system continues to monitor the vehicle position and time of travel (element 320). While monitoring this, the system determines whether the driver has heeded the warning and has returned to the prescribed route (element 322). If so, the system continues to monitor the position of the vehicle and time of travel (element 314). Otherwise, the system safely shuts off the vehicle engine (element 324) or otherwise disables the vehicle.

Thus, the present invention provides a computer system and vehicle navigation system for accessing map data, deriving route information from the map data, loading the route information onto a vehicle's ignition key, and determining deviation from an authorized route. When the user uses the vehicle key to start the engine of the vehicle, the route information is transferred from the vehicle's ignition key to the vehicle's ignition receiver. Within the vehicle is a GPS receiver and processor for determining the vehicle's position. The vehicle navigation system compares the vehicle's position to the route information to determine if the vehicle has deviated from a prescribed route or area or has exceeded an authorized travel time. If the driver of the vehicle deviates from the prescribed route or area by more than a predetermined amount the vehicle navigation and control system warns the driver to promptly return to the prescribed route. If the driver fails to heed the warning, the system will shut off the vehicle's engine. Or if the driver of the vehicle travels more than a predetermined distance from a point, the driver may be warned and the vehicle shut down if the warning is not heeded.

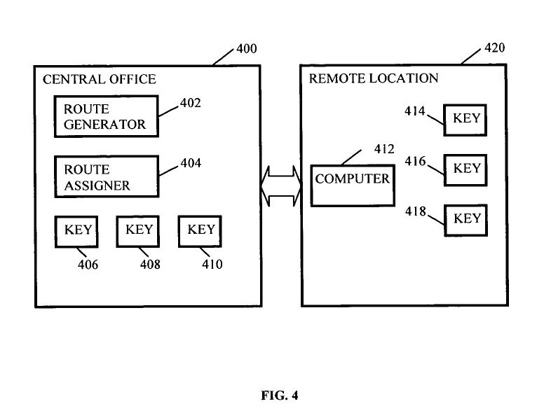

FIG. 4 shows an embodiment of the invention for assigning different routes to a plurality of different vehicles. Within a central office 400 is a route generator 402. Route generator 402 can generate different routes for different vehicles. A route assigner 404 assigns the different routes generated by route generator 402 to different vehicle keys as illustrated by keys 406, 408, and 410. Clearly, any number of keys can be assigned different routes or the same route. FIG. 4 also shows a remote location 420 comprising a computer 412 for receiving route assignments from the central office 400 and for transmitting the routes to the correct keys 414, 416, and 418.

The system shown in FIG. 4 is especially advantageous to delivery services. For example, a package delivery service may have a central office for regulating and assigning routes to its various vehicles in various locations. For example, the delivery service may have multiple vehicles at multiple locations that distribute packages in the area of each location. The computer system that transfers the route information to the key, verifies that it is sending the prescribed route information to the right key. In one embodiment, the system transmits the assigned route information and a unique key identifier to locations that have one or more vehicles. The computer system 412 receives and stores the assigned routes and key identifiers. When a user presents a key to system 412 to receive route information, the user causes the key to transfer its unique identifier to the computer. For example, the key may be equipped with an electronic transmitter that transmits electromagnetic waves upon which the information is impressed. Alternatively, an embodiment provides a card reader/writer for reading from and writing to a key card. The key is swiped through the card reader/writer to transmit information from the card to the computer and to the card from the computer. The computer then knows which route information to transmit to the key because the key's identity has been revealed to the computer. Thus, computer system 412 transmits to each key its assigned route.

In general, a computer program stored on a machine accessible medium may be provided to implement the methods of the present invention. Machine accessible media include hardrive media, compact disks such as CD or DVD, Read-Only-Memory, Random Access Memory, or any other media capable of storing executable instructions. The computer program of the present invention typically comprises a multitude of instructions translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature used herein is used merely for convenience, and thus the invention should not be limited to use solely in any specific application identified and/or implied by such nomenclature.

Although the present invention and its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer-implemented method for transferring route information to a navigation system in a vehicle, comprising:
receiving by the navigation system route information from a vehicle ignition key, wherein the vehicle ignition key enables a driver to start the vehicle engine;
determining vehicle position information; and
processing the route information and vehicle position information within the navigation system to determine an extent of deviation of the vehicle from an authorized condition of travel.

2. The method of claim 1, further comprising:
accessing map data from a map data base, wherein the map data comprises coordinates of routes;
processing the map data to determine route information comprising one or more routes between a point of origin and a destination point; and
transferring the route information to the vehicle ignition key.

3. The method of claim 1, further comprising:
accessing map data from a map data base, wherein the map data comprises coordinates of routes;
processing the map data to determine route information comprising an origin and a radius; and
transferring the route information to the vehicle ignition key.

4. The method of claim 1, wherein determining an extent of deviation of the vehicle from an authorized condition of travel comprises determining a distance between an authorized route and a position of the vehicle.

5. The method of claim 1, wherein determining an extent of deviation of the vehicle from an authorized condition of travel comprises: determining if the distance of the vehicle from a point exceeds a user-selected value.

6. The method of claim 1, wherein processing the route information comprises determining from map coordinates one or more authorized routes of travel.

7. The method of claim 1, further comprising issuing a warning to a driver of the vehicle if the vehicle deviates from the authorized condition of travel by more than a predetermined amount.

8. The method of claim 6, further comprising bringing the vehicle to a stop if the vehicle does not return to an authorized condition of travel in response to the warning.

9. The method of claim 1, further comprising
receiving a plurality of routes between points from a map database;
identifying one or more routes between two points from the plurality of routes;
selecting one or more of the one or more identified routes; and
transferring an identity of each selected route to the vehicle ignition key.

10. An apparatus for transferring route information to a navigation system in a vehicle, comprising:
a vehicle ignition key that stores and transmits route information to the navigation system and that enables a driver to start the vehicle engine; and
a receiver for receiving route information transmitted by the key;
a position determiner to determine vehicle position; and
a processor that receives the route information and the vehicle position and determines an extent of deviation from an authorized condition of travel.

11. The apparatus of claim 10, further comprising:
a map database providing geographical data;
a computer that accesses the map database in response to user-entered route parameters to determine route information; and
a mechanism for transferring route information from the computer to the vehicle ignition key.

12. The apparatus of claim 11, wherein the route information comprises the identity of one or more selected routes between two points, the one or more routes selected from a plurality of routes obtained from the map database.

13. The apparatus of claim 11, wherein the mechanism that transfers route information from the computer to the vehicle ignition key comprises a card writing device that writes data to a card that is used to start the ignition.

14. The apparatus of claim 11, wherein the computer communicates in a network of computers to transmit to computers in the network different sets of route information for different keys.

15. The apparatus of claim 10, wherein the route information comprises the identity of one or more selected routes between two points: the one or more routes selected from a plurality of routes obtained from a map database.

16. The apparatus of claim 10, further comprising a warning mechanism that warns a driver of the vehicle if the vehicle deviates from the authorized condition of travel by more than a predetermined amount.

17. The apparatus of claim 16, further comprising a mechanism to bring the vehicle to a stop if the vehicle does not return to an authorized condition of travel in response to a warning issued by the warning mechanism.

18. A machine-accessible medium containing instructions effective, when executing in a data processing system, to cause said data processing system to perform operations comprising:
receiving route information from a vehicle ignition key;
receiving vehicle position information from a receiver; and
processing the route information and vehicle position information to determine an extent of deviation of the vehicle from an authorized condition of travel.

19. The machine accessible medium of claim 17, wherein determining an extent of deviation comprises determining the distance between the position of the vehicle and a position along an authorized route.

20. The machine accessible medium of claim 17, further comprising issuing a warning in an extent of deviation of the vehicle from an authorized condition of travel exceeds a predetermined amount.
